(19) United States
(12) Patent Application Publication
(10) Pub. No.: US 2005/0177795 A1
(43) Pub. Date: Aug. 11, 2005

(54) Electronic document systems and methods

(76) Inventors: Jeffrey Weiss, Potomac, MD (US); Gerson Panitch, Potomac, MD (US)

Correspondence Address: WEISS & MOY PC, 4204 NORTH BROWN AVENUE, SCOTTSDALE, AZ, 85251, US

(21) Appl. No.: 11/040,713

(22) Filed: Jan. 21, 2005

Related U.S. Application Data
(60) Provisional application No. 60/538,127, filed on Jan. 21, 2004.

(51) Int. Cl. G06F 3/00; G06F 17/00

(52) U.S. Cl. 715/753; 715/764; 715/513; 715/512

(57) ABSTRACT

A system and method for enabling electronic use and presentation of exhibits at a deposition or like proceeding. Exhibits may be placed on a server, and selected for use at a deposition or like proceeding by a questioning attorney. The selected exhibit may be presented for marking and for display to one or more of a deponent and a non-questioning attorney. Annotation of selected exhibits and/or proposed exhibits by the questioning attorney and/or another attendee may also be permitted.

### RELATED APPLICATION

This non-provisional application claims priority from provisional application No. 60/538,127, filed on Jan. 21, 2004.

### TECHNICAL FIELD

Aspects of this invention relate generally to enabling electronic use and presentation of exhibits at a deposition or like proceeding.

### BACKGROUND

Typically, depositions in complex litigations require the copying and transportation of voluminous hard copies of deposition exhibits and potential deposition exhibits. In complex business cases, for example, some singular exhibits can each be hundreds of pages long. And for each deposition exhibit, there is typically an original copy marked by the court reporter for placement before the deponent, a copy for the attorney taking the deposition, and a courtesy copy for an attorney of each opponent or co-party attending the deposition. The questioning attorney and/or paralegals employed by the questioning attorney must therefore copy and organize a minimum of three sets of each document that might potentially become a deposition exhibit. Just the logistics of copying and organizing hard copies can involve many hours of attorney and/or paralegal time.

As a deposition progresses, it is not unusual for the questioning attorney to determine that documents once thought necessary, are no longer important. Thus, the volume of copies prepared for a deposition is often much greater than the documents ultimately used. It is also common for attorneys to decide during the deposition and/or shortly prior thereto to change the order of use of exhibits, with the result that the exhibits may no longer be organized in proper order. In addition, an attorney who may come to a deposition to defend the deponent or planning on not taking an active role in the deposition may decide, in light of testimony provided at the deposition, to undertake questioning and may which to present his or her own exhibits, yet be limited in the use of exhibits because of a failure to anticipate events at the deposition.

Often depositions occur outside the offices of the questioning attorney, requiring the transportation of boxes of documents to the site of the deposition. Airlines regularly charge $25 to $50 or more per box for each such item of this “extra luggage.” Sometimes, it is necessary to ship deposition exhibits separately, using a shipping service. Under either scenario, the questioning attorney is often at unease about the possibility that one or more of these boxes might be lost in transport.

When a deposition is complete, the court reporter is charged with gathering all the copies of the exhibits, for binding with the transcript when complete. Periodically, an original exhibit becomes lost in the sea of paper on the deposition table, and the fact that it is missing may not be discovered until weeks later when the court reporter begins assembling the final deposition package.

To avoid the logistical difficulties of carrying the unused documents and exhibit copies back home, the questioning attorney often employs the services of an overnight courier. And a hotel concierge facilitating the return may charge a service fee equaling the courier's fee.

In sum, the copying, organization, and transportation of hard copies to and from depositions, can easily exceed a thousand dollars per deposition, depending on the volume of documents involved. And the logistics of managing the exhibits from court reporter to attorneys after the deposition can also be quite costly.

### SUMMARY OF A FEW ASPECTS OF THE INVENTION

While the invention in its broadest sense is not limited to judicial proceedings, it may have particular benefit in connection with depositions. In one sense, the invention may involve displaying documents at a deposition in electronic form. According to one embodiment, the invention may permit exhibits to be electronically marked at the deposition. The invention may also involve more than one display device employed at the deposition so that the questioning attorney views, on a separate display, the same document presented to the witness. Additional displays may be provided for additional attorneys present. In one embodiment, the questioning attorney may be able to annotate an electronic document in advance of or at a deposition, without the annotations being viewable by anyone other than the questioning attorney.

Software associated with the questioning attorney's computer may permit the organization and reorganization, in real time, of a sequence of documents to be marked as exhibits. If the documents have been run through an OCR program, the questioning attorney may be permitted to search the text of all exhibits or potential exhibits for a particular word or phrase. Alternatively, the questioning attorney may be permitted to search or display documents by predesignated categories or to search the text of notes associated with the document in advance by the questioning attorney.

When the deposition is complete, all of the deposition exhibits may be immediately stored on a CD, flash memory, or other electronic storage medium handed to the court reporter and/or opposing counsel, and/or copied to a hard drive or other location for later transmission. Alternatively or in addition, the deposition exhibits may be electronically mailed to one or more desired e-mail addresses following the conclusion of the deposition. As a yet further alternative and/or in addition, some or all of the deposition exhibits may be printed in hard copy form, for filing or other purposes.

The invention may also involve business methods. For example, a court reporter may provide services consistent with the above description, and charge a fee for that service. Alternatively, a business method may involve licensing a number of users at a law firm or deposition service provider, and charging the licensed entity a periodic fixed usage fee and/or a fee per usage. The business method might also involve rental of hardware and the provision of support services.

### DESCRIPTION OF PREFERRED EMBODIMENTS

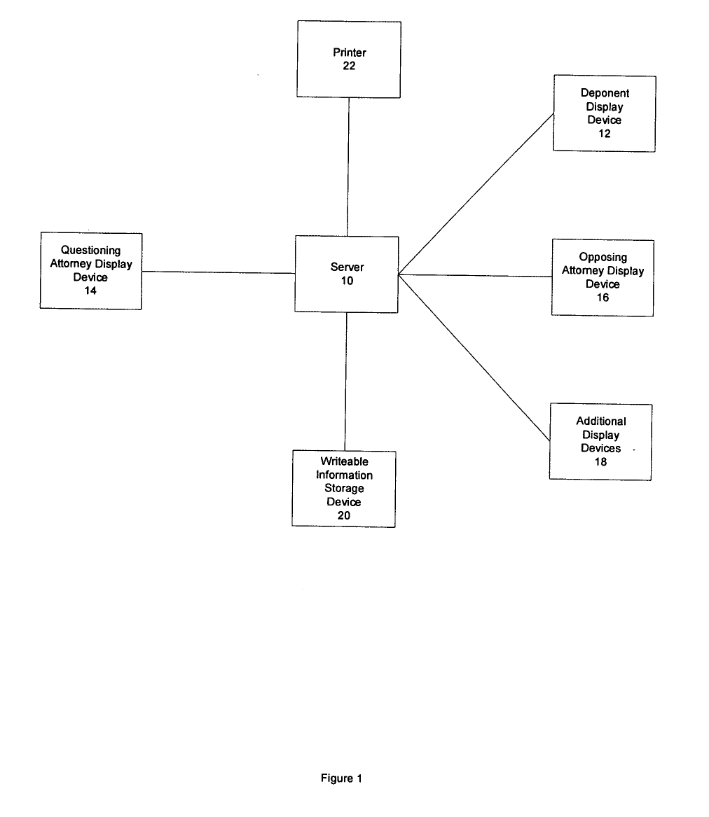

In general, the invention may be used in connection with depositions, in a system such as is illustrated in FIG. 1. In FIG. 1, a central server 10 may serve document images to various display devices in wired or wireless communication with the server 10. The server may transmit images to a display device 12, positioned for viewing by a deponent. The server may also be configured to send document images to one or more of a display device 14, configured for viewing by a questioning attorney, a display device 16, configured for viewing by a defending attorney, and one or more display devices 18, configured for viewing by others such as the attorney(s) of co-plaintiff's, co-defendants, or in-house counsel.

The server may include a processor and storage device contained within a portable computer of the questioning attorney. In such an instance, the server may be part of the same hardware configuration as display device 14. Alternatively, the server may be supplied by the court reporter or a separate service provider.

The server may also be associated with a writeable information storage device 20, such as a CD burner, flash memory device or any other device capable of providing interested parties and/or the court reporter with a portable record of the exhibits used in a deposition. Alternatively, the exhibits may be transmitted to interested parties and/or the court reporter over a network, such as the Internet, or could be mailed in hard or electronic form at a later date. Still further, the server may also be associated with at least one and possibly a plurality of printers 22, so that hard copies of one or more of the exhibits can be generated. Such generation of a hard copy via one or more printer 22 may be for the benefit of one or more of the attendees during the conduct of the deposition, for example to ease the burden of reviewing a lengthy document or to benefit an attendee who does not wish to utilize a display device for some reason. Hard copies may also be generated upon the completion of the deposition, for recordkeeping or other purposes.

While illustrated as a unitary component for ease of discussion, a server as referred to herein may include a plurality of components that may or may not be located at a single location. By way of example only, some exhibits might be served via a CD ROM, others via flash memory, and still others via a networked storage device remote from the location of the deposition.

The display devices 12, 14, 16, and 18, could take one or more of multiple forms. CRT monitors, flat panel monitors, or tablet monitors may be used. It may be desired to provide two or more of the display devices 12, 14, 16 and 18 coupled to a common support member, so that the common support member can be positioned, for example, in the middle of the table being used for the deposition. The display devices coupled to the common support member can be attached in a fixed manner, or the position of the angle and perhaps height of the display devices in relation to the common support member may be adjustable. The use of such an apparatus can standardize positioning of the display devices 12, 14, 16 and/or 18, and can also ease the burden of transporting multiple display devices 12, 14, 16 and/or 18 to and from a deposition.

The display devices may simply be screens, or they may include their own central processing units. For example, display devices 12, 14, 16, and 18 might be laptop PCs, tablet PCs, desktop PCs, or any other display mechanism permitting visual output and/or input. Systems might be mix and match. By way of example only, the questioning attorney's display device 12 might be a laptop PC, the deponent's display device may be a tablet PC, and the other's display devices 16,18, might simply be flat screen monitors. In an alternative embodiment, server 10 might be connected to a projector, such as an LCD projector, for permitting multiple participants to simultaneously view a document.

Although not critical to the invention in its broadest sense, one benefit of providing the deponent with a device such as a tablet PC or other display device permitting the marking of an image displayed thereon is that it may permit the deponent to mark up a document during the deposition using, for example, a pen-like stylus. For example, in a technical deposition, a witness may be asked to circle and label a portion of a blueprint about which the deponent is testifying. Such markings could then be captured and permanently stored as part of the exhibit. Similarly, a deponent may be asked to create an exhibit, such as the sketch of an intersection of an accident. A tablet PC or other display device permitting document marking would permit the deponent to create such a document electronically during a deposition. Tablet PCs and laptops are also compact, making them easy to transport to a deposition.

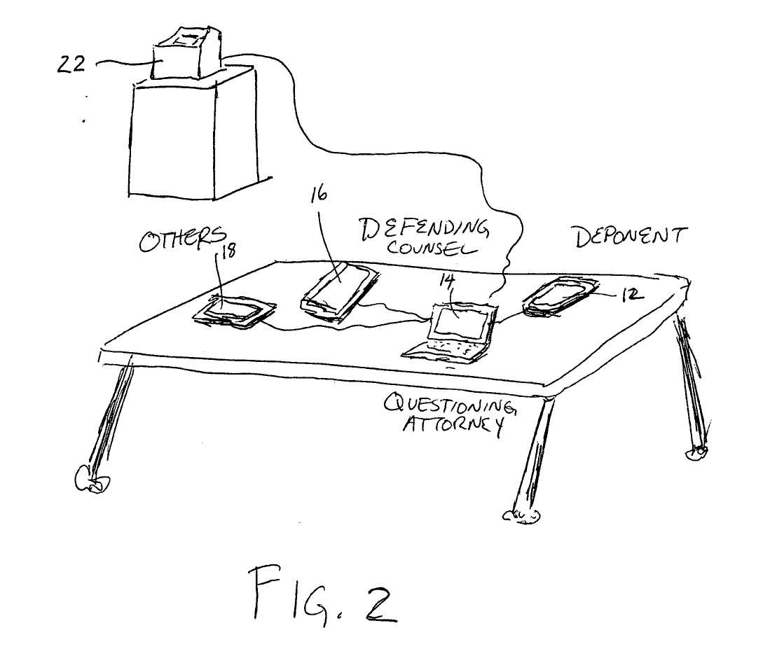

By way of example only, one hardware configuration is illustrated in FIG. 2. In that figure, the questioning attorney's laptop PC may act both as server 10 and display device 14. The USB ports or other connections on the questioning attorney's computer may act as connections to display devices 12, 16, and 18. A wired or wireless router (not shown) might also be employed to direct exhibit images to the various display devices. In this configuration, a CD burner, contained within the questioning attorney's laptop PC, may serve as writeable information storage device 20. For security or authenticity reasons, it may be desired to locate the writeable information storage device 20 under the control of a court reporter or other deposition monitor, with the court reporter or other deposition monitor controlling server 10.

During a deposition, software associated with the server may permit the questioning attorney to prescreen an exhibit before serving it to the other displays. Once served to the other displays, software might automatically mark the exhibit with an electronic marker bearing the exhibit number, or permit marking by the court reporter or other deposition monitor. The marker may take the form of the image of a conventional exhibit sticker, such as those that are now typically affixed to exhibits during depositions. Alternatively, the exhibit number may appear as indicia across the top or bottom margin. Smart software might identify a blank space on the document in which to place the exhibit indicia. A person present at the deposition, such as the court reporter or a deposing attorney may be permitted to drag and drop the electronic “sticker” at a preferred location. Alternatively, the exhibit image might be slightly reduced in size to make room for the indicia. Non-visible electronic markings might also be inserted as a precaution against later tampering.

The exhibit numbers may be applied automatically. That is, the driving software may record each new exhibit in numerical sequence, permitting exhibits to be auto-numbered. If a questioning attorney wishes to have the witness create an exhibit, the system may permit the questioning attorney to serve up a blank exhibit page to the witness.

Before a deposition, a questioning attorney generally reviews the prospective deposition exhibits, annotates a working copy of each with notes and questions, and organizes the prospective exhibits by topic or in some other manner. All this may be done electronically in accordance with one embodiment of the invention. For example, the questioning attorney, working with a tablet PC or some other input device, may be permitted to annotate each page of a document. Those annotations may be associated with the document in a layered fashion without altering the underlying document image. In this way, when a document is displayed during the deposition, the document may appear on the questioning attorney's display device 14 with the attorney's earlier annotations, but may appear on all other display devices 12, 16, and 18 as the underlying document, without any of the questioning attorney's annotations. The annotations may additionally and/or alternatively appear on a separate screen or in a window.

Annotations themselves may be searchable by the questioning attorney. For example if the witness opens up a topic of negligence, the attorney might at that point decide to question the witness on related documents. The attorney might then search for all documents with annotations containing the word “negligence,” prescreen them, and decide whether to serve them up as exhibits.

If a questioning attorney is working with a colleague who is “second chairing” or otherwise attending the deposition, rights may be provided so that the server displays the confidential annotations on the colleague's display device as well. In such an instance, the colleague may be able to annotate the document in real time during the deposition, for viewing by the questioning attorney. The colleague's annotations may appear on the questioning attorney's display in a color different from the questioning attorneys own annotations. In this manner, the second chair may be able to silently communicate questions or thoughts to the questioning attorney during the course of the deposition. The second chair may also be permitted to prescreen potential exhibits and electronically suggest them on the first chair's monitor, or in a window on the first chair's monitor. The second chair may be an attorney, paralegal, or a non-legal professional, such as a client or client representative.

Software may permit the questioning attorney to tag documents in many differing ways, providing the questioning attorney with ultimate flexibility during the deposition. For example, documents could be pre-tagged with one or more of a priority designation, a chronological designation, and various topical designations. Therefore, a questioning attorney who begins a deposition with a plan to question in a preset order, can shift strategies mid stream to a topical approach, and then later return to the preset plan. If time is running out, the questioning attorney might then switch to a priority approach to ensure that the most important documents are not inadvertently overlooked. Similarly, if documents are stored in an OCR format, the questioning might search the full or partial text of all stored documents, and select an exhibit in that alternative manner. Or as discussed previously, documents might be selected by searching attorney annotations.

It should be noted that the terms “questioning attorney” and “first chair” refer to the attorney who is then questioning the deponent. The questioning attorney may be the attorney who noticed the deposition, it may be an attorney who is defending the deposition and who is then asking his/her own questions of the deponent and presenting exhibits, and it may be an attorney representing a third party who is then asking questions and presenting exhibits to the deponent. The term opposing attorney refers to any attorney participating in the deposition who is not then questioning the deponent. In other words, during the course of a deposition, the identity of the questioning and opposing attorneys can change. While the attorney who has noticed the deposition is the most likely to benefit from the system and method described herein, it is preferred that whichever attorney is then questioning the deponent may have the ability to electronically present exhibits to the deponent as described herein.

Once a deposition exhibit is marked, the system might permit the document to be instantly recalled in any one of a number of different ways. For example a drop down menu might permit the questioner and or the deponent to click on an exhibit number to retrieve the exhibit. Alternatively, the questioner might remember a particular phrase in the document or the annotations, and the subset of marked exhibits might be searchable in that manner.

Other embodiments may include integrating the exhibit server software with real time deposition transcription software, such as Livenote. This might enable the testimony about a previously discussed document to be retrieved at the same time a previously marked document is retrieved, or vise versa. If used in connection with a program such as Livenote, the questioning attorney may use two separate display devices, or integration software may permit both testimony and exhibits to be viewed on the same display device. In such an instance split screens and/or toggle screens may be employed.

In one embodiment, the questioning attorney may have the ability to continue electronically annotating the document during the deposition, without those annotations appearing on any of the other display devices 12, 16, or 18.

To alleviate a concern that a technical failure might delay a deposition, the questioning attorney might securely post the deposition exhibits to a network, such as the Internet, in advance of a deposition. In the event of a storage system failure, the documents might be retrieved over the network. In addition, the server itself might be available over a network, enabling the entire process to occur through network connections. While such a configuration may be particularly useful in the event of technical difficulties with hardware at the deposition site, it might also be useful in remote depositions (i.e., depositions taken by telephone or video conference), permitting the deponent and questioning attorney to view the same documents. In addition, it might alleviate the need to transmit hard copies of the exhibits by courier in advance of such a remote deposition.

If a network is used, a posting party might be permitted to password protect (or otherwise securely protect such as with a USB key or the like) the exhibits so that no one might open them prior to commencement of the deposition. The system might further permit the poster to withhold annotations from the posting in the event the poster is concerned that unauthorized access to the exhibits might occur in advance of the deposition.

It is important to note that the technical details of the hardware and networks described above are not considered to be limiting of the invention in its broadest sense. With the rapid change in computing devices, display devices, storage devices, and networking devices that have occurred over the last decade and which are continuing to occur, it is the general concepts that constitute the broadest aspects of the invention and not the specific hardware and networking details.

According to one exemplary embodiment of the invention, there may be provided a method for utilizing electronic deposition exhibits, including causing electronic representations of a plurality of deposition exhibits to be loaded onto a server. “Causing” may include one or more of storing representations on a server, directing or suggesting to another to store representations on a server, or directly or indirectly transmitting the representations to another with the understanding that the recipient will store the representations or will direct another to store the representations.

The electronic representations may be any form of protocol in which exhibits might be stored. By way of example only, electronic representations of hard copy documents might be stored in a .pdf form. For electronic representations of electronic documents such as e-mails or web sites, the electronic representations might be stored in a word processing format (e.g., Word document), html format, or other electronic storage format. It is contemplated that as technology further develops, new mechanisms will become available for storing information in compressed and non-compressed manners. The invention is not limited to any existing mechanism, and is contemplated to encompass those currently existing and those that might exist in the future.

An embodiment of the invention may further include enabling a questioning attorney to select at least one of the deposition exhibits for use during a deposition. As embodied herein, an attorney may be enabled by providing the attorney or an affiliate or assistant of the attorney with the tools to select deposition exhibits. Such tools might include one or more of hardware and/or software configured to permit the selection of a deposition exhibit. The term “select” refers to a decision to use information in a deposition.

The invention may further include enabling an electronic presentation of the selected deposition exhibit to a deponent at the deposition. Again, an electronic presentation may be enabled by providing hardware and/or software tools that cause the selected deposition exhibit to be presented to a deponent. A law firm, for example, may enable one or more of the selection and/or presentation, by providing one of its attorneys with a computer configured to operate in the electronic deposition environment of the invention. Similarly, a court reporting service might enable either activity by actively participating in a deposition where such software and/or hardware is used, or by making some or all of such tools available to the attorney. Third party providers might enable either activity by making available one or more of the hardware or software used with the system. And the questioning attorney and opposing attorney (or an affiliate of either) is said to enable either activity by participating in a deposition in which a system consistent with the invention is used.

An embodiment of the invention may further include associating with the selected deposition exhibit an electronic deposition exhibit designation. The electronic deposition designation may include any identifying indicia, such as, for example, and exhibit number or letter, regardless of the appearance (or lack thereof) of the indicia, how the indicia is formatted, or how the indicia is stored. Various examples were previously discussed. Associating may occur manually, automatically, or quasi automatically. It is intended that the term associating includes either using, providing, or facilitating the use of a system in which an identifying indicia is connected with the exhibit, whether that connection occurs before or during the deposition. Thus, associating may occur directly through the use of a system that links an exhibit designation to the deposition exhibit, and may also occur by providing hardware or software configured to make such a linkage.

Additionally, an embodiment of the invention may include electronically retaining, after the deposition, the selected deposition exhibit and the associated electronic deposition designation. Retaining occurs, for example, by storing the electronic deposition designation in a manner that causes the designation to be associated with the selected deposition exhibit; by providing or using a system or components of a system through the use of which an electronic deposition designation is linked in some fashion to the selected exhibit, or by assisting one who uses a system with such a feature. Thus, retaining may occur directly through the use of a system that stores an exhibit designation, and may also occur by providing hardware or software configured to store such a designation.

An embodiment of the invention may further include enabling the questioning attorney to annotate the selected deposition exhibit in advance of the deposition, and to view the annotations during the deposition. As embodied herein, enabling such predeposition annotations may include the act of making the annotations and/or providing hardware or software used to make the annotations. Annotations, as used herein, includes one or more of written text, typed text, a presentation order tag, a topical tag, an tag identifying a level of importance, a key word tag, or any other information added by the attorney or an affiliate of the attorney to aid the attorney during the deposition.

In a preferred embodiment, the annotations may be blocked from viewing by all but the questioning attorney (and affiliates of the questioning attorney) during the deposition. Thus, in such an embodiment, the display on the screen(s) of the witness and opposing attorney(s) may be devoid of any attorney annotations, while the screen(s) of the questioning attorney (and perhaps affiliates) may display the annotations.

Some embodiments of the invention may also include one or more business methods. For example, one such model involves a network service provider enabling attorneys to access a remote server that handles the deposition exhibits over a network such as the Internet. Billing models might be based on one or more of an elapsed time, number of exhibits, or number of displays. Alternatively, a software provider might license attorney users for a limited period of time/number of uses before the license needs to be renewed. Licensing fees might be a function of one or more of the number of depositions taken, the number of exhibits marked, or a fixed period of usage.

Alternatively, a software provider might license a court reporter to provide the exhibit service.

It should be noted that while, in one embodiment, the systems and methods of the present invention are concerned with depositions, they may have application in other contexts as well. For example, they may be utilized during a seminar, board meeting, business meeting, class, or the like, wherein one or more persons makes a presentation for the benefit of a plurality of others. In this regard, rather than viewing the presentation on a screen or the like, individual attendees may receive the presentation on attendee display devices in communication with a presenter display device. In this embodiment, preferably, attendee display devices permit the taking of notes, inputting of comments or receipt of other input (e.g., highlighting, etc.) with respect to the presentation displayed thereon, and its saving for later use.

1. An electronic document display system for a deposition comprising, in combination:
a server for retaining a plurality of deposition exhibits thereon;
a questioning attorney display device for connection to the server, and adapted to display thereon at least some of the plurality of deposition exhibits stored on the server and selected by the questioning attorney; and
a deponent display device coupled to the server and adapted to display thereon the deposition exhibits selected by the questioning attorney.

2. The system of claim 1, further comprising an opposing attorney display device coupled to the sever and adapted to display thereon the deposition exhibits that are selected by the questioning attorney.

3. The system of claim 1 further comprising a printer coupled to the server.

4. The system of claim 1 further comprising a writeable information storage device coupled to the server.

5. The system of claim 1 further comprising at least one additional display device coupled to the server.

6. A method for utilizing electronic deposition exhibits, the method comprising:
causing electronic representations of a plurality of deposition exhibits to be loaded onto a a server;
enabling a questioning attorney to select at least one of the deposition exhibits for use during a deposition;
enabling an electronic presentation of the selected deposition exhibit to a deponent at the deposition;
associating with the selected deposition exhibit an electronic deposition exhibit designation; and
electronically retaining, after the deposition, the selected deposition exhibit and the associated electronic deposition designation.

7. The method of claim 6 further comprising presenting the selected deposition exhibit to an opposing attorney on a monitor separate from the monitor on which a presentation is made to the deponent.

8. The method of claim 6 further comprising writing the selected deposition exhibit and the associated deposition exhibit designation to a writeable information storage device.

9. The method of claim 6 further comprising transmitting the marked deposition exhibit over a network after completion of a deposition session.

10. The method of claim 6 further including enabling a deponent to make visible markings on the selected deposition exhibit and electronicallystoring on the server the visible markings made by the deponent.

11. The method of claim 6 further comprising enabling the questioning attorney to annotate the selected deposition exhibit in advance of the deposition, and to view the annotations during the deposition.

12. The method of claim 6, further including enabling a court reporter to retain the selected deposition exhibit for transmittal to the questioning attorney after the deposition.

13. The method of claim 6, further including enabling the questioning attorney to leave the deposition with a copy of the selected deposition exhibit with the associated deposition designation.

14. The method of claim 6 further including enabling a non-questioning attendee to annotate the selected deposition exhibit during the deposition.

15. The method of claim 14 further including enabling the electronic display to the questioning attorney of the selected deposition exhibit as annotated by the non-questioning attendee.

16. The method of claim 6 further including enabling a non-questioning attendee to selected a proposed deposition exhibit during the deposition and to electronically display to the questioning attorney the proposed deposition exhibit.

17. The method of claim 6 wherein at least some electronic representations of a plurality of deposition exhibits are maintained at a location remote from the deposition for electronic access over a network during the deposition.

18. The method of claim 17 further comprising offering use of equipment associated with the method via a deposition services company, and charging users a fee for use of the equipment.

19. The method of claim 6 further comprising offering at least one of hardware and software associated with the method to a user, and charging the user a fee therefore.

20. The method of claims claim 19 or 20, wherein the fee is based on one or more of a fixed fee, an hourly fee, a yearly fee, a per diem fee, or a periodic license, or and a number of presented exhibits.
